(19) United States
(12) Patent Application Publication
(10) Pub. No.: US 2004/0158723 A1
(43) Pub. Date: Aug. 12, 2004

(54) Methods for providing high-integrity enrollments into biometric authentication databases

(76) Inventor: David C. Root, West Chester, PA (US)

Correspondence Address: DAVID C. ROOT, 331 OLD BAILEY LN, WEST CHESTER, PA, 19382, US

(21) Appl. No.: 10/359,177

(22) Filed: Feb. 6, 2003

(51) Int. Cl. H04L 9/00

(52) U.S. Cl. 713/186

(57) ABSTRACT

Without control over the point of enrollment into biometric authentication databases, fraudulent enrollment is an expected consequence. Such enrollment fraud would minimize the potential benefits derived from the superior authentication capabilities offered, in varying degrees, by different biometric technologies. In a world where identity theft and fraud is rising along with the consequences of said behavior, a better enrollment system is needed. This present invention is intended to control the point of enrollment into biometric authentication databases, limiting said enrollments to only those identity/biometric data pairings that have been certified by this invention (process) to some level of identity-integrity. This present invention is further intended to allow a greater level of confidence in the identity-integrity of transactions authenticated with a higher level of certified trust than is available through other authentication methods, or even through biometric authentication provided by this invention at lower certified levels of trust.

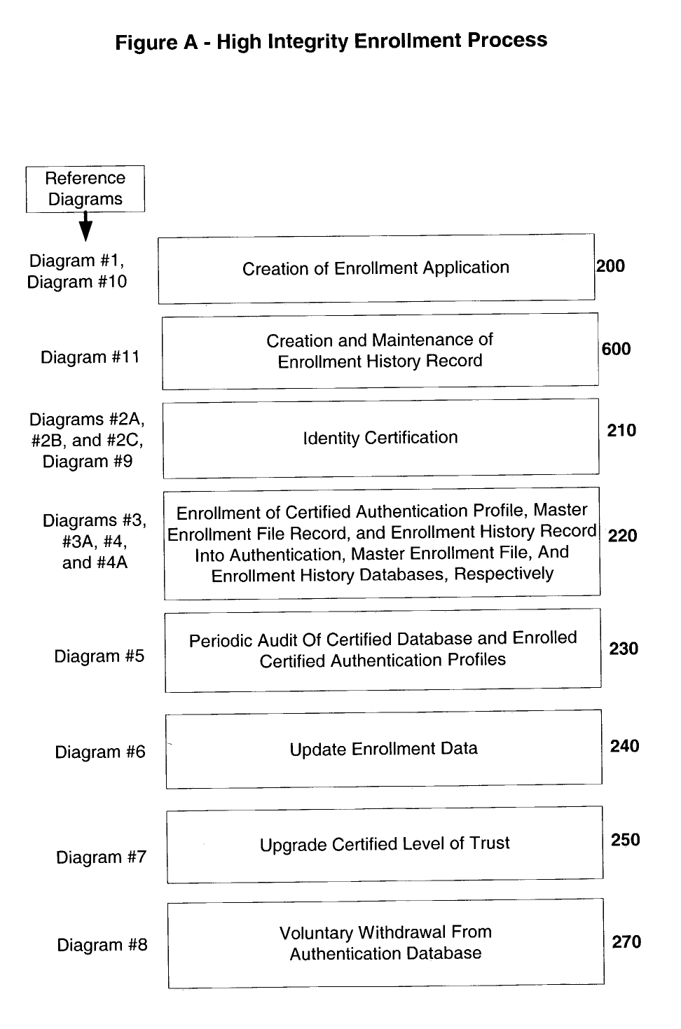

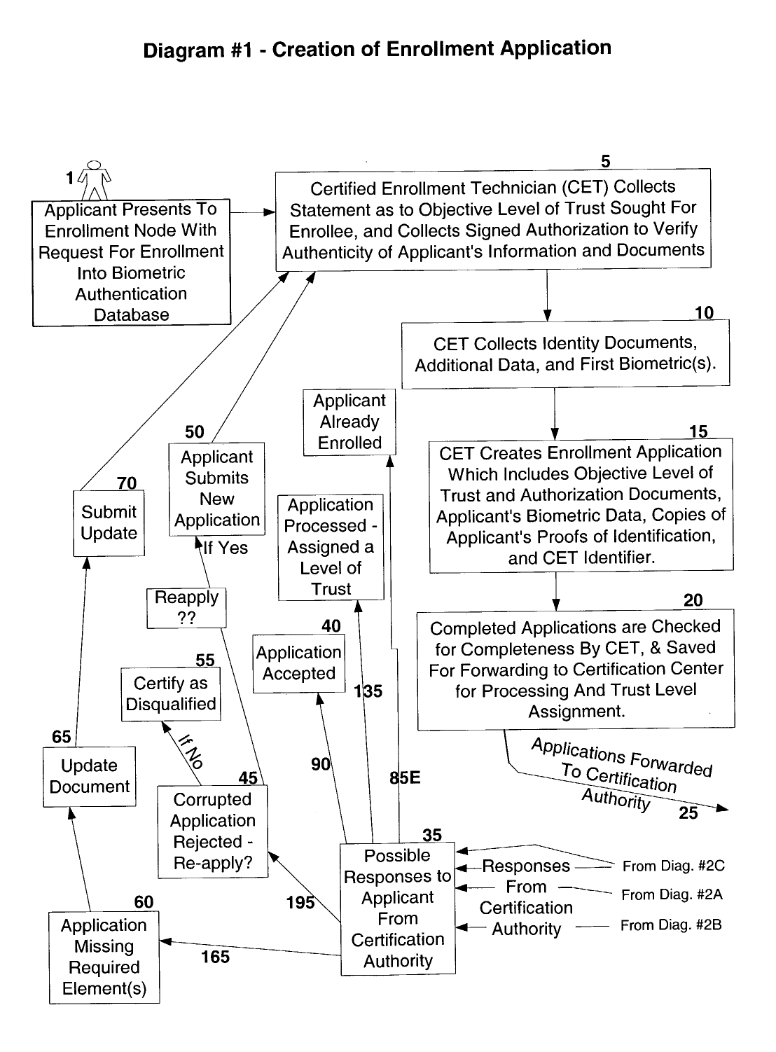

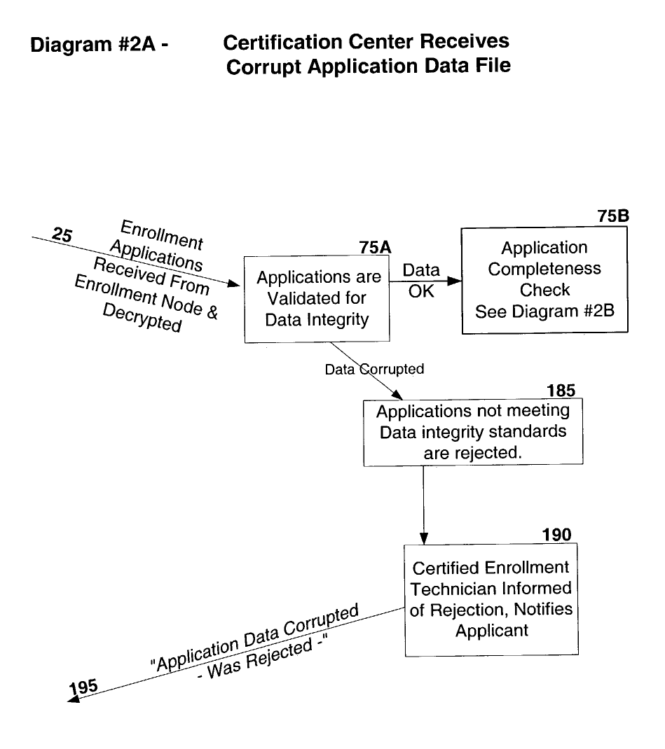

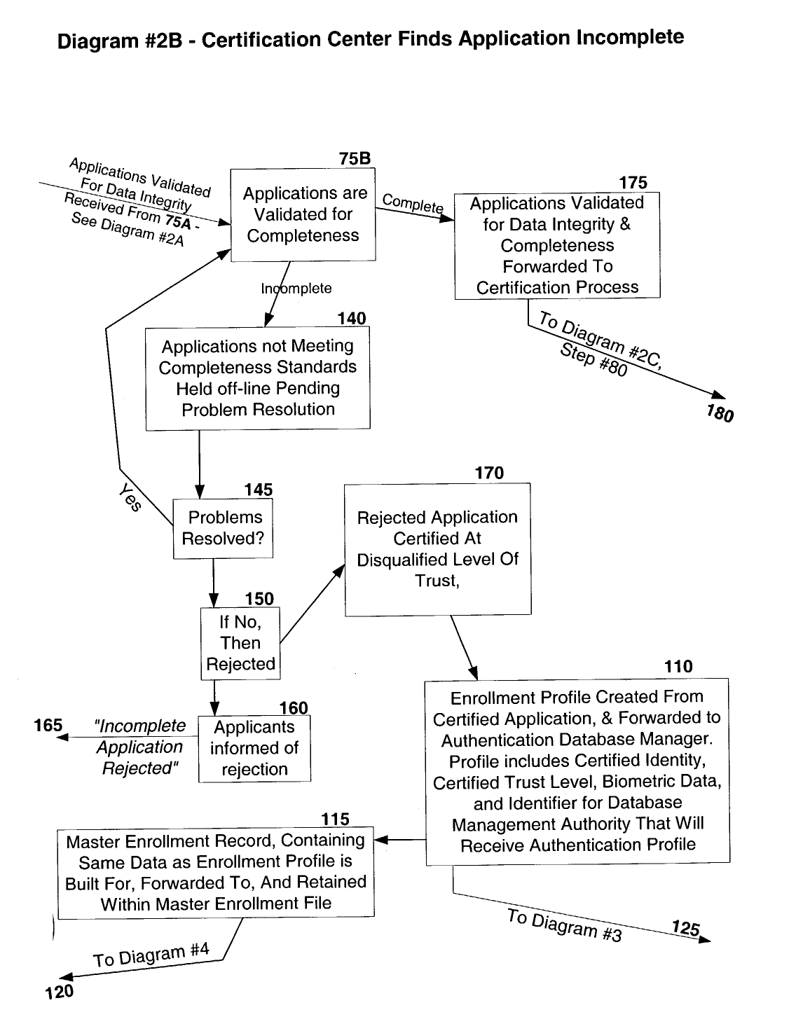

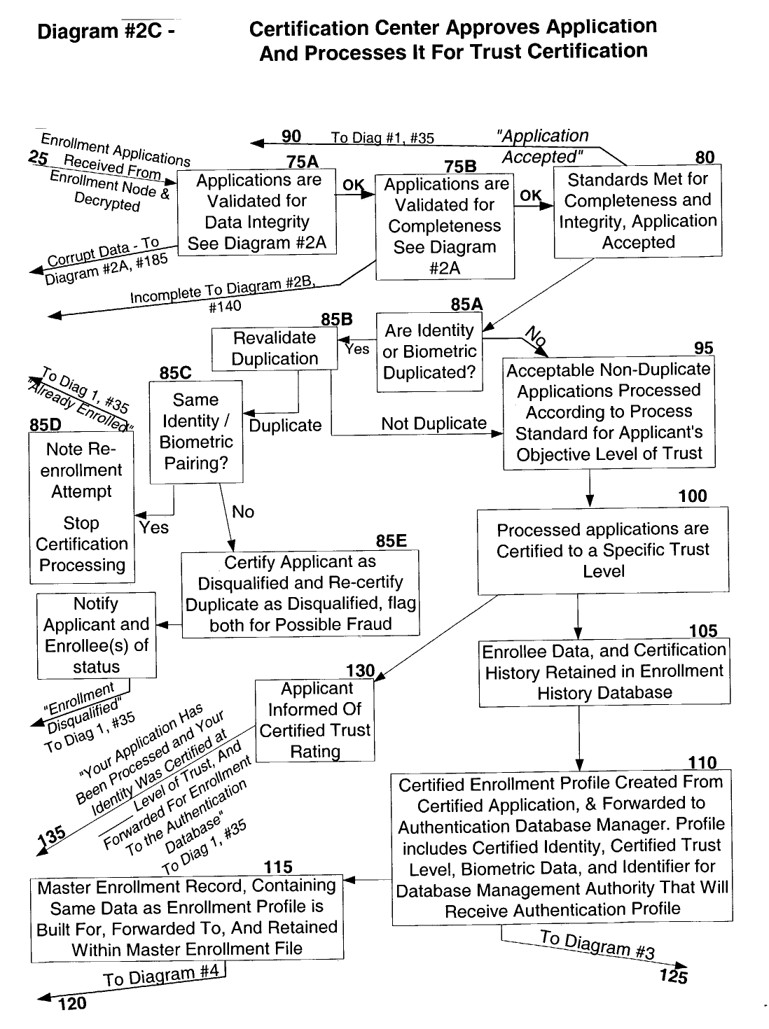

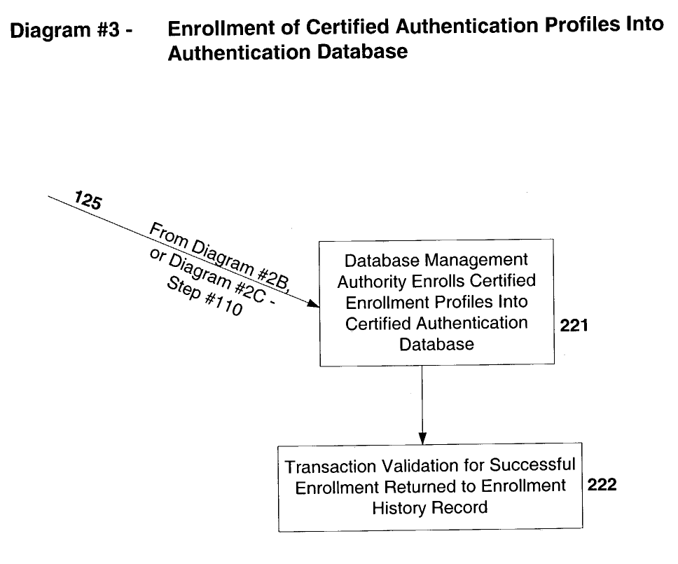

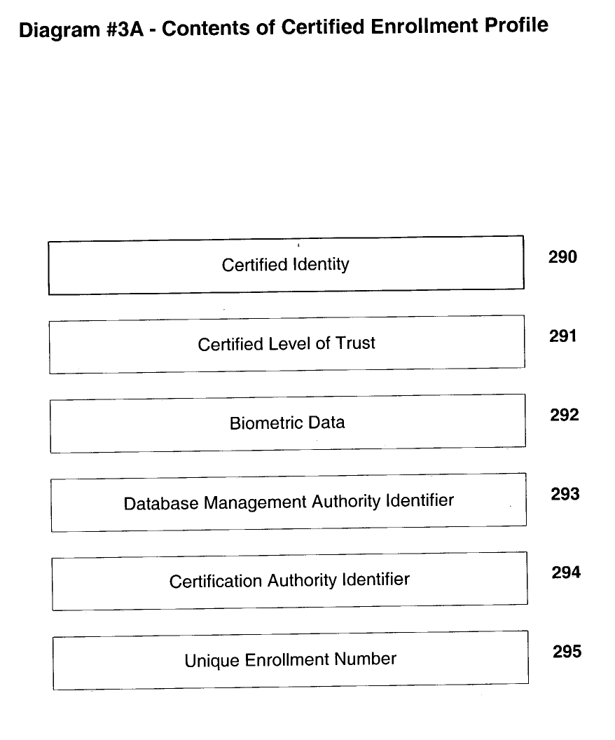

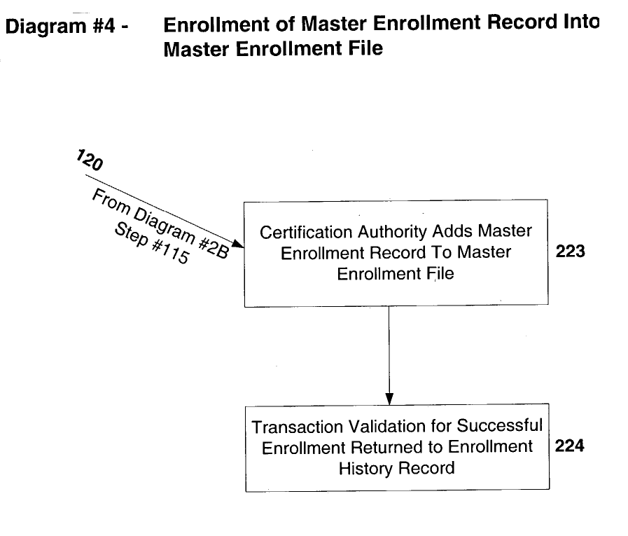

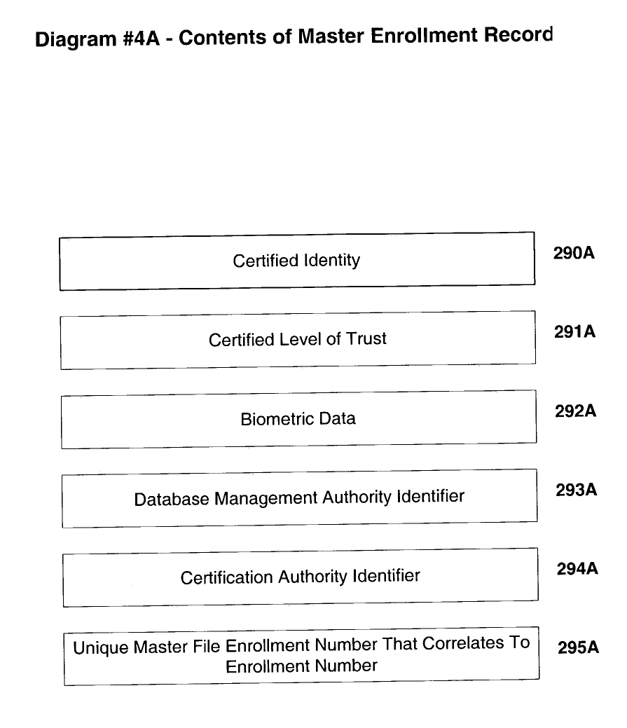

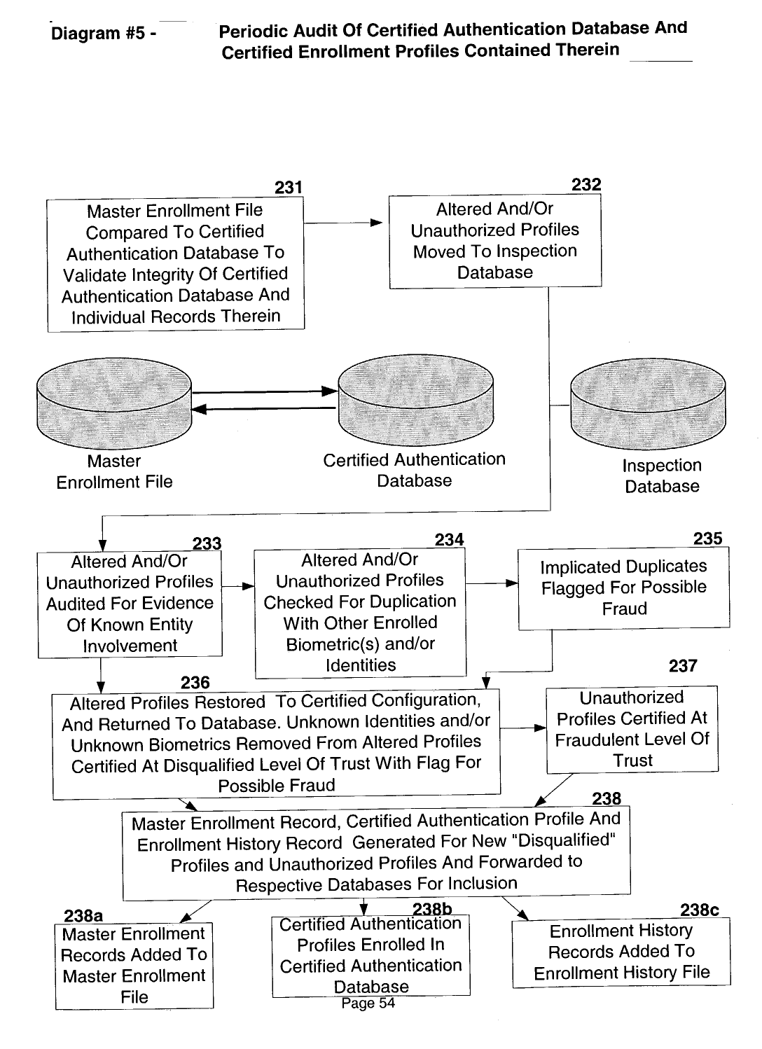

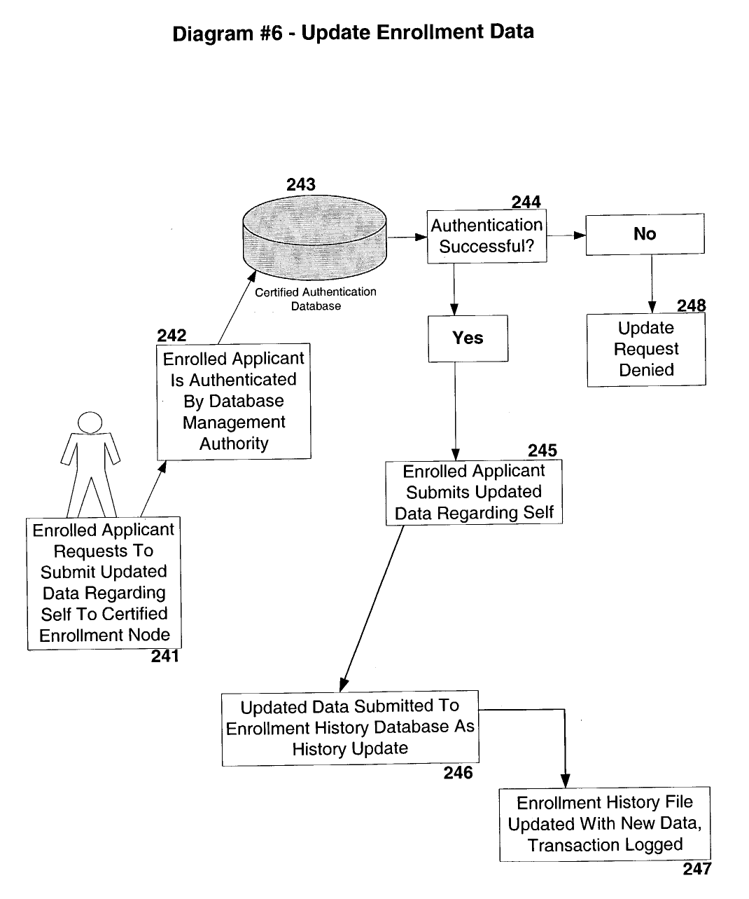

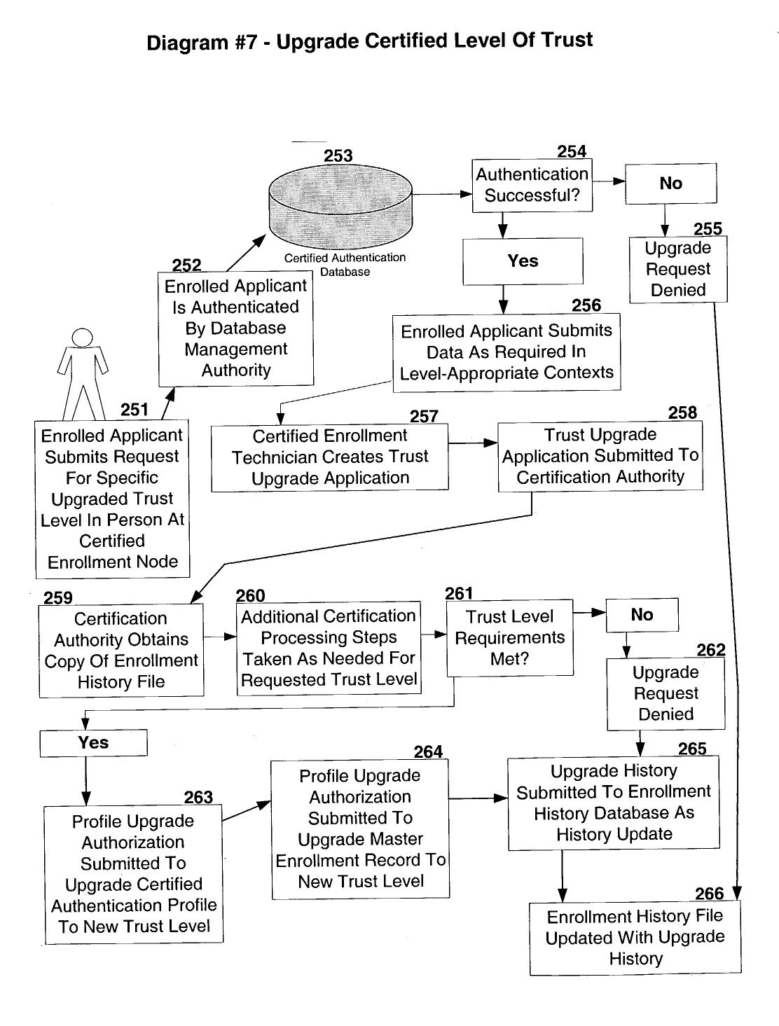

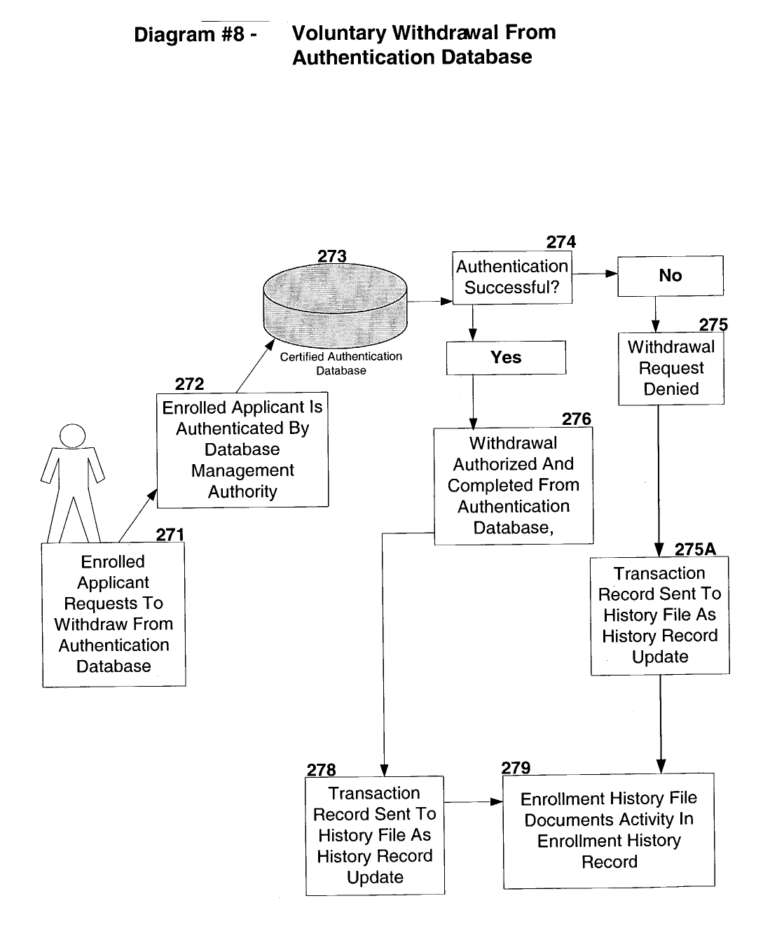

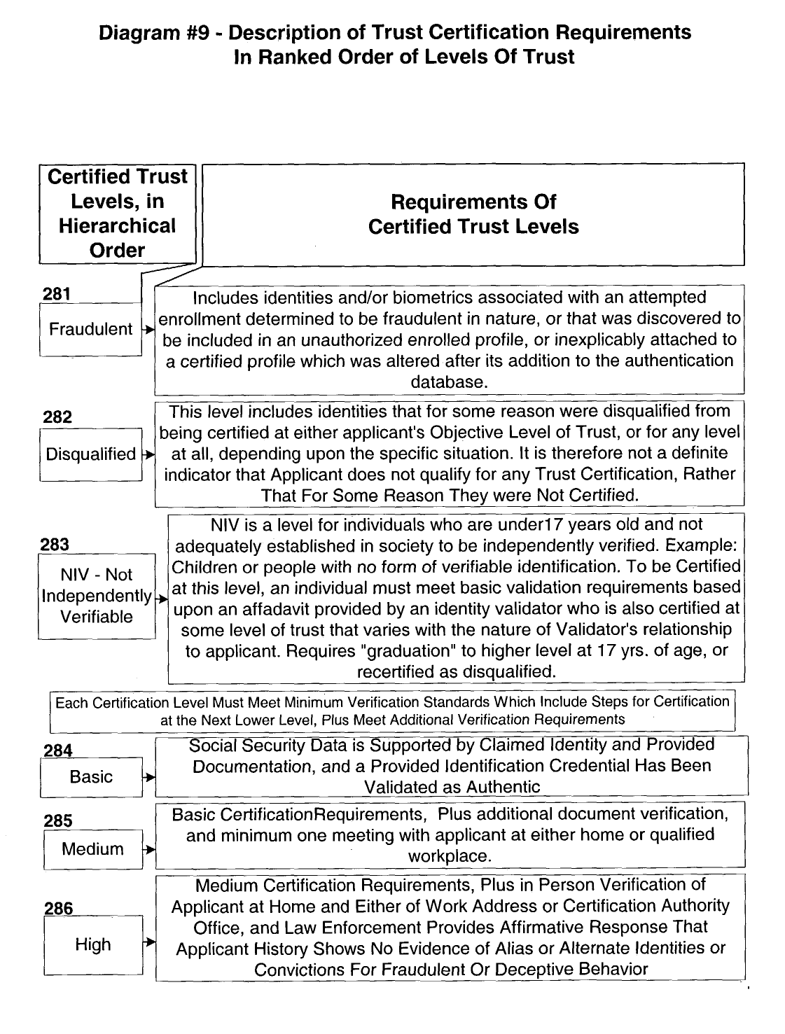

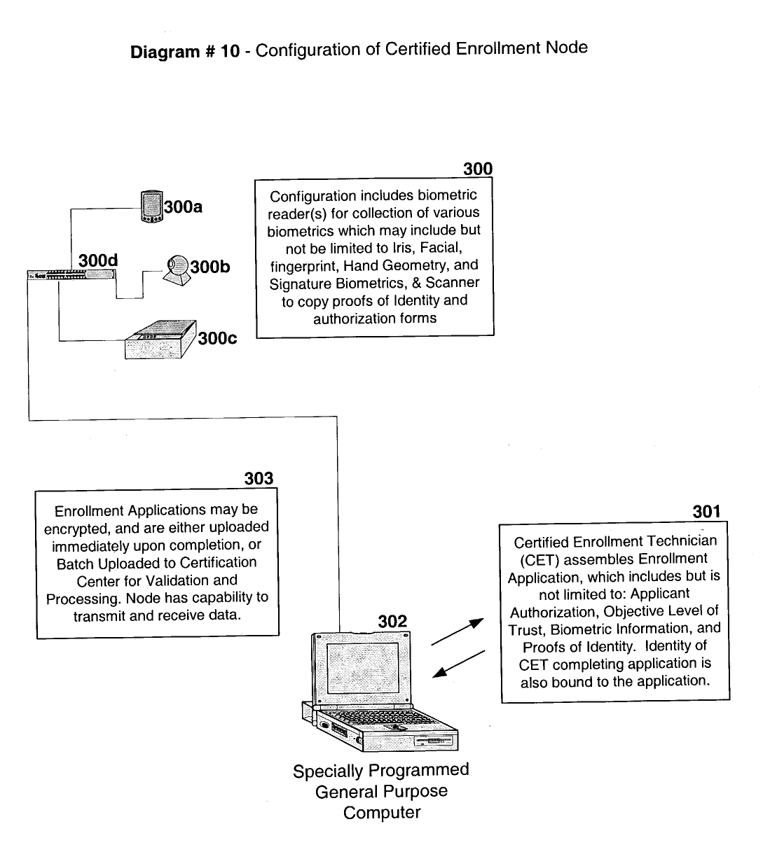

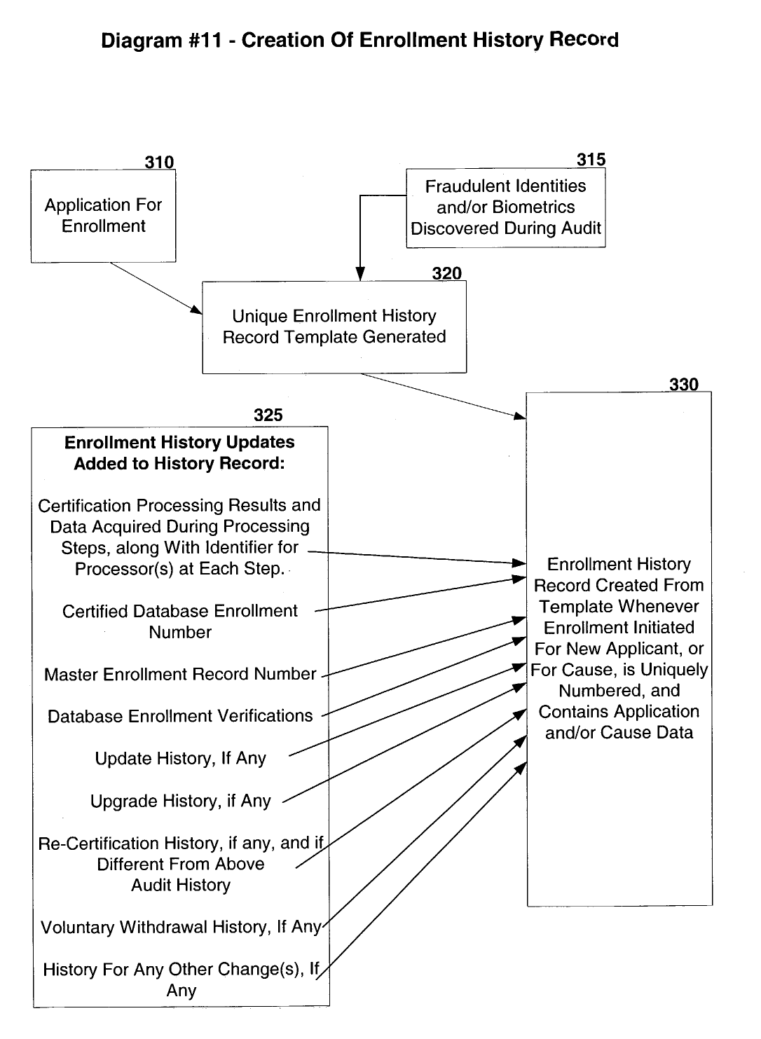

### TECHNICAL FIELD

The present invention relates to biometric authentication systems, and more particularly, to the process and methods for providing high-integrity enrollments into biometric authentication databases. As used herein: high-integrity means providing a level of assurance, prior to an identity's enrollment into a biometric authentication database, that a prospective enrollee's claimed identity is valid and not previously enrolled in association with a different set of biometrics and/or that the prospective enrollees biometrics were neither previously enrolled nor enrolled in association with a different identity. High-integrity is further enhanced by periodic audits to ensure the continued integrity of both the authentication database and the identity/biometric pairings (records) contained therein.

### BACKGROUND OF THE INVENTION

In many instances it is necessary to verify the identity of an individual who is requesting some form of access. This access may be either physical, electronic, or to a thing or substance under some form of control. Examples of physical access would include but not be limited to airport terminals, office buildings, hydro-electric or nuclear power generation facilities, national monuments, or any location where identity-specific access privileges are used to restrict access to physical space. Examples of electronic access would include but not be limited to such services as on-line banking and stock-trading services, internet shopping, and data-access services, and could be made available to a prospective user either in person, or via some form of electronic access. Included here would also be access to private or corporate computer networks. Examples of access to a thing or controlled substance would include but not be limited to in-person bank withdrawals, or the purchase of alcohol, tobacco and firearms.

The method of authenticating the identity of individuals prior to granting them access to such facilities, services, or things is typically performed using forms of proofs of identity that are increasingly easy to either forge or gain unauthorized access to: such as printed identification cards or a knowledge of someone's personal data, including passwords, user ID's, personal identification numbers (PINS) or other personal information such as name, address, social security number, date of birth, or mother's maiden name. Knowledge of this personal data is often accepted as proof of identity, yet as a means of identification, the system is vulnerable to fraud. This is because this information may be easily obtained. Increasingly sophisticated yet inexpensive printing capabilities also make it easier to produce fraudulent forms of printed identification, thereby enabling individuals to assume alternate identities.

The inability of people to remember passwords, PINs, user IDs, or recent transactions is another reason why the more complex forms of knowledge based identification systems are vulnerable to unauthorized access. Many users write access information down and leave it in conspicuous places like post-it notes on computer monitors. Some even write their ATM PIN numbers on the backs of their ATM cards. The easy access to authentication data can make it very simple to gain unauthorized access to money or other resources.

These shortcomings have prompted an increasing interest in biometric security technology, namely, verifying a person's identity with unique personal biological characteristics. Examples of biometric authentication technologies include iris recognition, face recognition, signature recognition, hand geometry, fingerprint, voice recognition, and retinal print. In the existing art, biometric authentication is performed using one of two methodologies. In the first, verification, individuals wishing to be authenticated are enrolled in the biometric system. In this example, a sample biometric measurement is provided by the individual, along with personal identifying information, or some information unique to that individual. The sample biometric is stored along with the personal identification data in a database.

When the individual seeks to be authenticated, he or she submits a second biometric sample, along with the relevant personal identifying information, such as described above, that is unique to that person. The personal identifying information is used to retrieve the person's initial biometric sample from the database. This first sample is compared to the second sample, and if said samples are judged to match by some criteria specific to the biometric technology, then the individual is authenticated.

The second form of biometric authentication is identification. Like in verification, the individual must be enrolled in a biometric database where each record includes a first biometric sample and accompanying personal identifying information. In order to be authenticated the individual submits only a second biometric sample, but no identifying information. The second biometric sample is compared against all first biometric samples in the database and a single matching first sample is found by applying a match criteria, at which the personal information associated with the biometric is released. The advantage of this second form of authentication is that the individual does not need to be in possession of the unique identifying information required in the verification method to retrieve a single first biometric sample from the database.

The weakness of biometric systems in general lies where biometric identity is created, the point where biometric data is first associated with a claimed identity, namely, the point of enrollment into the database(s). Unless identity is validated prior to enrollment, there is the potential for someone to assume a fraudulent electronic identity, causing subsequent authentications performed on that person to erroneously validate them as the assumed or stolen identity. In methods that are most often utilized at the point of enrollment, identity documents are usually accepted at face value as being legitimate, without any effort to systematically evaluate the legitimacy of said identity credentials. Such credentials are frequently falsified. It could therefore be fairly simple for an individual who desires to commit electronic identity fraud to be enrolled under an assumed or stolen identity into biometric authentication systems. Biometric authentication and/or identification technologies are typically implemented in situations where access control is important to protect valuable assets, sensitive data, or to secure physical space. Without a validation step to confirm the legitimacy of the identity documents produced by prospective enrollees into biometric authentication systems, we are merely enabling the recreation of fraudulent identities in electronic form within the very system being depended upon to provide higher levels of control against unauthorized access.

If we are to realize the potential and intended benefits of biometrics as an enhanced access security technology, there must be a system that controls the point where electronic biometric identity is created: the point at which or process by which an identity is initially associated with a biometric before the authentication record is added to the authentication database. This point is generally called the point of enrollment. Without the identity-integrity obtained by control over the point of enrollment, an individual could steal or assume a different or fictitious identity, and use said identity to be enrolled into a trusted biometric authentication database. A consequence of this scenario could be that systems designed to restrict access could be circumvented by an individual who assumes a trusted but false identity. Said individual could subsequently be authenticated by the system as trusted wherever the biometric technology has been implemented. Considering the potential loss of life and property that could result from such corruption by terrorists or other criminals, it is important to minimize the ability of such individuals to corrupt a biometric authentication system through fraudulent enrollment. According to Information Technology (IT) security companies and organizations such as RSA, Verisign, InfraGard and others: incidents of computer hacking, electronic corporate espionage, and electronic vandalism are on the rise. It is therefore also important to put in place a method for validating, on a regular basis, that only the validated identities are enrolled within the authentication database, and that none of the validated enrollments have been subsequently tampered with.

On Jan. 23, 2003, the New York times reported in their article “Identity Theft Complaints Double in '02” that the Federal Trade Commission reported that we live in a world where identity theft is on the rise. The majority of the two-fold increase in identity theft over the previous year was from internet related (electronic) fraud, with a significant portion coming from bank and loan fraud.

With terror, identity theft, and computer crime having become such a recognized threat, it is important to build safeguards that will add a level of identity-integrity to electronic and point-of-use identity authentication systems.

Enrollment methodologies have typically been implemented to meet the case-by-case requirements of organizations implementing biometric authentication technology. Human resource departments, IT departments, or even a single individual may be given the task. Many biometric technologies even allow for “self-enrollment” as an option in the administrator's user interface. The self enrollment model would enable anyone with computer access to create a biometric identity. The involvement of IT and Human Resource departments would still not eliminate the problem in an environment where forms of identification documents are accepted at face value as proofs of identity. If there is not a validation step that verifies the probable integrity of said identity documents and even the identity itself, there exists a likelihood that enrollment fraud or abuse will take place.

History has shown that vulnerabilities such as these are very likely to be exploited to some level of personal, corporate, public, or national detriment.

Biometric Authentication technology has the potential of providing the necessary level of identity-integrity, if adequate control is placed over the points of enrollment and a post enrollment audit system is also implemented. Without such control, biometrics will merely validate that the identity claimed by an individual who seeks to be authenticated is the same identity as was claimed by applicant and associated with their presented biometric at the time of enrollment, whether fraudulent or not. What a biometric technology will NOT do is reveal whether an individual being authenticated actually owns the identity they claim. In short, there exists a need for a biometric database enrollment process that validates the true ownership by an individual of a claimed identity prior to the association of said identity with their biometric data within a biometric authentication database, and that periodically audits said database to ensure that their biometric identity has not subsequently been altered. The current invention addresses this need.

### SUMMARY OF THE INVENTION

This present invention is directed to a system and method that controls the process of enrollment into a biometric authentication database in order to ensure that said authentication database is comprised solely of identity/biometric authentication profiles for which it had been verified to some degree of confidence that each identity reflected therein actually belonged to the individual who claimed it before said identity was associated with said individual's biometric data within said biometric authentication database. The system and method are designed with the intention of working in support of any biometric authentication technology which may be selected for implementation by an entity intending to utilize a biometric authentication technology. The system and method described herein also contains a system to assign one of several increasing levels of trust to the validity of said identity, with said trust level reflecting the extent of verification of said identity that was successfully performed regarding its validity prior to the assignment of said Level of Trust. The system and method that controls the process of enrollment also contains a system to audit a biometric database and enrollments contained therein on a periodic basis to detect any unauthorized additions or changes that may have been made to said database or authentication profiles. Thus, the high-integrity enrollment method of this current invention solves the identity-integrity concerns expressed above because enrolled identities are validated prior to their respective enrollments, and the ongoing integrity of said enrollments and database is also audited on a regular basis. The high-integrity enrollment method of this current invention provides an improvement over conventional methods of enrollment because the enrollment process for an authentication database being built using this system is more difficult to circumvent by individuals intent upon fraudulently enrolling. Improvement is also provided because the level of integrity that can consequently be ascribed to authentication transactions provided by a database built using controls as are described within this current invention is far higher than can legitimately be ascribed to authentication transactions provided by a database built using current biometric database enrollment methods. The high-integrity enrollment method of this current invention provides an additional improvement over conventional methods of enrollment because of the varied levels of trust that may be associated to individual identities enrolled within the authentication database. Said varied levels of trust enable a single authentication database built upon this system and method to be used to provide centralized control over access to facilities, services, or things, the sensitivity of unauthorized access to which varies depending upon the nature of the specific facility, service, or thing that the authentication database is controlling access to. The high-integrity enrollment method of this current invention provides an additional improvement over conventional methods of enrollment because it enables the expected Level of Trustworthiness assignable to an authentication transaction originating from an authentication database built upon this present invention to be more closely in line with the technical limitations of the specific biometric technology(ies) implemented therein. These limitations are generally agreed upon by those skilled in the art of biometric technologies.

One of many applied examples of this improvement would be access control implemented for employees at an airport, where one might accurately presume that different levels of trust would be appropriate regarding the authentication of individuals being considered for access to physical areas such as: control tower, computer room where authentication database and other airport operating systems and the computers on which they reside are located, location where baggage is loaded onto aircraft or stored prior to such loading, where maintenance is performed on aircraft, to aircraft themselves between flights, to controls over the points of inspection of passengers and their luggage, to passenger concourses, or to employee bathrooms.

The high-integrity enrollment system and method includes systems for: creating an application for enrollment that contains the data elements required for certification of applicant's identity to applicant's desired Level of Trust; certifying said identity to a specific Level of Trust; enrollment of certified identity into biometric authentication database; auditing of said certified identity(ies) and their respective authentication database(s); updating enrollment data; upgrading certified Level of Trust, and withdrawing identity from authentication database.

The high-integrity enrollment system and method include a method for creating an application for enrollment into a biometric authentication database including a trained individual operating an enrollment node to create application for enrollment into biometric authentication database, and to forward said application to Certification Centers for certification processing. The system for creating said application for enrollment includes: a specially trained operator operating an enrollment node. The system for creating application for enrollment including an enrollment node which may include: specially programmed general purpose computer with data communication capability; biometric acquisition device(s); document scanner; digital camera; printer; and forms to be completed for inclusion within said enrollment application. The enrollment node may also include a specially developed device which, by itself, includes either: the aggregated capability to perform more than one of the functions provided by other devices previously listed; or the fractional capability to perform a part of the function of one of the devices previously listed. The system and method for creating a high-integrity enrollment application may include steps of: signing an authorization to validate proofs of identity, data, and other documentation provided by applicant; signing a request to be certified at one of several potential levels of trust; capture by node operator of first biometric(s) of applicant; collection by operator of additional data, and/or copies of form(s) of identification, and copies of other documentation provided by applicant; providing copies of signed documents to applicant; performance of validation check by operator to confirm provision by applicant of all documentation required for trust certification at their requested Level of Trust; saving of said enrollment application; and forwarding of said saved enrollment application to certification authority for certification processing.

The data stored in any device or component thereof, used during or within the completion of any step or component of a step or method comprising a component of or the entirety of this process and/or systems may be encrypted using conventional techniques, such as public-key and private-key techniques. Similarly, the data as noted above, and/or the equipment used in connection with any component of this process and/or these systems may be protected using conventional techniques such as firewalls, access control systems or devices, or chain of custody processes.

The high-integrity enrollment system and method include a method for certifying an identity to a specific Level of Trust. The method for certifying an identity to a specific Level of Trust may include the steps of: validating the completeness of applications received from enrollment node(s) in accordance with requirements for requested Level of Trust; validating that neither applicant or their biometrics are previously enrolled in authentication database; validating the authenticity of proofs of identity and other documents and data provided by applicant in accordance with requirements for requested Level of Trust; determining Level of Trust for which applicant identity has qualified relative to the trust level said applicant had requested; assigning a specific Level of Trust certification to applicant's claimed identity; creation of master enrollment file record; creation of certified authentication database enrollment profile; creation of Enrollment History Record; forwarding of said records and profile to managers of the appropriate respective databases for addition into said databases.

The high-integrity enrollment system and method includes a method for adding certified enrollment profile into the certified authentication database. The method for adding certified enrollment profile into the certified authentication database includes a method for validating successful addition of certified enrollment profile into the certified authentication database.

The high-integrity enrollment system and method includes a method for adding master enrollment record into the master enrollment file. The method for adding master enrollment record into the Master Enrollment File includes a method for validating successful addition of master enrollment record into the master enrollment file.

The high-integrity enrollment system and method includes a method for adding Enrollment History Record into the enrollment history database. The method for adding Enrollment History Record into the enrollment history database includes a method for validating successful addition of master enrollment records into the master enrollment file.

The high-integrity enrollment system and method includes a method for auditing certified database(s) and the certified enrollment profiles therein. The method for auditing certified database(s) and the certified enrollment profiles therein also includes a method for the handling of unauthorized or altered records.

An implementation of this present invention may also include an implementation of one or more of the biometric authentication technologies that the use of this high-integrity enrollment system was intended to support. Said authentication technology would be implemented for the purpose of using the authentication database developed using this present invention to authenticate the identity of an individual who desires to perform any of the steps, systems or methods contained within this present invention that require said individual to be biometrically authenticated as a component of said step, system or method. In any such authentication scenario: an authentication transaction identifier provided by said authentication technology would become component of the individual's Enrollment History Record.

The high-integrity enrollment system and method includes a method for updating identity related background data within the Enrollment History Record associated with said identity.

The high-integrity enrollment system and method includes a method for an individual to upgrade the Certified Level of Trust associated with their specific identity residing within a certified authentication database.

The high-integrity enrollment system and method includes a method for an individual to voluntarily have their authentication profile removed from the respective authentication database.

### BRIEF DESCRIPTION OF THE DIAGRAMS

The foregoing and other aspects of the present invention will become apparent from the following detailed description of the invention when considered in conjunction with the accompanying drawings. For the purpose of illustrating the invention, there are shown in the drawings embodiments that are presently preferred, it being understood, however, that the invention is not limited to the specific methods and instrumentalities disclosed. In the drawings:

Figure A is a diagram of an exemplary high integrity enrollment system in accordance with the present invention. Figure A also lists reference diagrams as they further describe the high-integrity enrollment system exemplified therein.

Diagram #1 is a diagram of an exemplary system for creating applications for enrollment and of possible responses to applicant from certification authority in the high integrity enrollment system of Figure A.

Diagram #2A is a diagram of an exemplary system for the management of corrupt application files as may be received by the certification center that would certify an identity in the high integrity enrollment process of Figure A.

Diagram #2B is a diagram of an exemplary system for the management of incomplete applications for enrollment as may be received by the certification center that would certify an identity in the high integrity enrollment process of Figure A.

Diagram #2C is a diagram of an exemplary system for the management and certification of applications for authentication database enrollment as may be received by the certification center in a condition that satisfies data integrity requirements and application completeness requirements for the system that would certify an identity to a Level of Trust in the high integrity enrollment process of Figure A.

Diagram #3 is a diagram of an exemplary system for the enrollment of certified authentication profiles into the authentication database supported by and deemed certified because of its use of the high integrity enrollment process of Figure A to manage and certify identities within the enrollments used to compile said authentication database referred to in Figure A.

Diagram #3A is a diagram of the contents of an exemplary certified enrollment profile as would be enrolled into a certified authentication database as in Diagram #3.

Diagram #4 is a diagram of an exemplary system for the enrollment of Master Enrollment Records into the Master Enrollment File as it is used in the high integrity enrollment process of Figure A.

Diagram #4A is a diagram of the contents of an exemplary master enrollment record as would be added the Master Enrollment File in Diagram #4.

Diagram #5 is a diagram of an exemplary system for the periodic audit of a certified authentication database and of the certified authentication profiles contained therein as is performed to contribute to the ongoing high-integrity of the enrollment process of Figure A.

Diagram #6 is a diagram of an exemplary system for the periodic update of applicant specific data as may be requested by an applicant enrolled as a certified identity in the high integrity enrollment process of Figure A.

Diagram #7 is a diagram of an exemplary system for the periodic upgrade of the Certified Level of Trust assigned to an applicant's identity, as may be requested by an applicant enrolled as certified identity in the high integrity enrollment process of Figure A.

Diagram #8 is a diagram of an exemplary system for the voluntary removal from the certified authentication database of an applicant's certified authentication profile as may be requested by an applicant enrolled as certified identity in the high integrity enrollment process of Figure A.

Diagram #9 is a diagram of an exemplary system of certification requirements for the assignment of a certified trust rating to an identity considered for enrollment in the high integrity enrollment process of Figure A.

Diagram #10 is a diagram of an exemplary enrollment node to be used for the collection of elements required for the creation of an application for enrollment as in the high integrity enrollment process of Figure A.

Diagram #11 is a diagram of the Creation of an exemplary Enrollment History Record as would be added to the Enrollment History Database in Figure A, #220.

### SUMMARY OF THE INVENTION

The present invention is directed to a system and method that validates an individual's identity and assigns a Certified Level of Trust to said identity based upon the probable likelihood that said identity actually belongs to the individual claiming the identity at the time of their requested enrollment into the database. This present invention controls the point of enrollment into biometric authentication databases, limiting said enrollments to only those identity/biometric data pairings that have been certified by this process to some level of identity-integrity.

### DETAILED DESCRIPTION OF THE PREFERRED EMBODIMENTS

As described herein, this present invention defines “Certified Enrollment Technician” 5 as a trained individual duly authorized to use a certified enrollment node Diagram #10 to create applications for enrollment into a certified biometric authentication database. 5,10,15,20 in Diagram #1.

As also described herein, this present invention defines a “Certified Enrollment Node” Diagram #10 as specially programmed general purpose computer to which devices have been attached for the purpose of collecting the data that comprises the application for enrollment. 5,10,15,20 in Diagram #1.

As described herein, this present invention defines “Certification Authority” as the entity performing the identity trust certification process as is described herein Diagrams #2A, 2B, and 2C. Further: this present invention defines “Database Management Authority” as the entity managing the Certified Authentication Database 221 being built from certified enrollment profiles Diagram #3A provided to it by certification authority. Said Database Management Authority is understood to be, and defined as the entity that manages the Certified Authentication Database 221 used to provide biometric authentication services, and may or may not be the same entity as the Certification Authority.

As described herein, a “Certified Enrollment Profile” Diagram #3A is defined as a biometric authentication database record that has been created using the process described in this present invention. A “Certified Authentication Database” 221 is defined as a biometric authentication database that is comprised solely of Certified Enrollment Profiles Diagram #3A,110, 221 as described herein.

As described in this current invention, “Objective Level of Trust” 5, 95 is defined as the specific certified trust level Diagram #9 requested by applicant for applicant's authentication record at the time said applicant requests enrollment 1 or at the time of request for subsequent certification upgrade should a change in trust level Diagram #7 be requested for applicant's identity.

This present invention defines a “Certified Level of Trust” Diagram #9 as the a trust rating assigned to a specific identity that, in turn, reflects a specific degree to which said identity has been successfully validated and which is intended, by virtue of its assignment to said identity, to reflect a probable likelihood that applicant's claimed identity is in fact valid, and that said identity has met the validation standards required for certification at said Certified Level of Trust. Diagram #9 This present invention requires increased steps or effort to be taken to validate an identity that is to be certified at a higher Level of Trust. Diagram #9

As described herein, this present invention defines “point of enrollment” as the point of entry into a biometric authentication database, and includes the process used to enroll an identity into said authentication database, the timeframe within which said enrollment process transpires, and the physical location at which the enrollment data for said enrollment is collected and/or processed for the purpose of completing said enrollment. For the purpose of this present invention, said process timeframe and physical location are constituted as follows: process is as described within this present invention; timeframe commences when an individual presents him/her self or is presented to Certification Authority 1, at some certified enrollment node(location) Diagram #10 for the purpose of being enrolled into a certified biometric authentication database Diagram #3, with transaction validation received by and added to Enrollment History Database Diagram #3, 222, & Diagram #11 and is completed when a Certified Enrollment Profile Diagram #3A for said individual is added to a Certified Authentication Database 221, Diagram #3. Location is also defined as including the location(s) of each of the enrollment node Diagram #10, 1, certification authority and database management authority.

In this present invention, “Master Enrollment File” 115, Diagram #4A is defined as a database comprised of Master Enrollment Records Diagram #4A which are tagged to reflect the associated certified authentication record 110 Diagram #3A, of which they are an associated copy.

In this present invention, the act of enrollment is described herein in the singular tense to reflect that enrollment is performed on a per person basis, with the understanding that while an authentication database may only include one authentication record, enrollment is intended for quantities of people.

The present invention is directed to a process that brings identity-integrity to biometric authentication by validating an individual's claimed identity before the biometric data of said individual is associated with the said claimed identity within a certified enrollment profile Diagram #3A in a certified authentication database 221 Diagram #3A, and to subsequently audit Diagram #5 said database to ensure that only such certified enrollment profiles Diagram #3A are present, and that none of said profiles have been altered since their addition to the database. Additionally, one of six levels of trust Diagram #9 will have been assigned to the validity of each identity during the certification process Diagrams #2A, #2B, & #2C, with the assignment level having been determined either by the level of validation of the claimed identity that was successfully completed, or for cause Diagram #2C. The level of validation performed upon said identity would have been, in turn, determined by the Objective Level of Trust Diagram #9, 5 requested by said individual 1, 5 for whom enrollment to the database is sought, with higher levels of validation being performed in order to assign higher levels of trust Diagram #9. In one preferred embodiment, the high integrity enrollment system including a system for creating an application for enrollment into a biometric authentication database Diagram #1, and a system for the validation of the identity claimed within said application Diagrams 2A, 2B, & 2C and assigning one of six levels of trust Diagram #9 to said identity, and a system for the generation and delivery of a Certified Authentication Profile Diagram #3A to the authority that manages the certified biometric authentication database 110 Diagram #3, a Master Enrollment Record Diagram #4A to the entity that manages the Master Enrollment File 115 Diagram#4, and an Enrollment History Record Diagram #11 to the authority that manages the enrollment history database, and a system to audit said biometric authentication database Diagram #5 to ensure that only certified authentication profiles Diagram #3A are contained therein, and that none of said certified authentication profiles Diagram #3A have been altered since their respective additions to the biometric authentication database. 110, Diagram #3

In a preferred embodiment of this present invention, during the process of creating an application for enrollment Diagram #1 into a biometric authentication database, an Applicant 1 presents themself to a Certified Enrollment Technician 5 at a Certified Enrollment Node Diagram #10, and authorizes the validation of their claimed identity 5, requests an Objective Level of Trust 5 Diagram #9, provides identification documents 10, and submits first biometric(s) 10 to complete said application. For applications requesting higher levels of certified trust Diagram #9, application may require additional data elements in order to be deemed “complete”. For each applicant, the Certified Enrollment Technician 5 opens a blank Application Template which will have required Certified Enrollment Technician 5 to be biometrically authenticated in order to access. Said template, once opened, contains identifier for Certified Enrollment Technician 5 who initiated it, and a unique application number, and each application is ultimately accounted for to the Certification Authority. Certified Enrollment Technician 5 then adds said Applicant's authorizations and request for an objective Level of Trust, biometric(s), and any other required data elements Diagram #9 into said enrollment application. Application self verifies that all required elements of said application are included considering the Objective Level of Trust Diagram #9, and Certified Enrollment Technician 5 also checks that application was correctly completed.

In another preferred embodiment of this present invention, Certified Enrollment Technician 5 then saves said application in encrypted form 20 for subsequent submission to Certification Center for identity certification 25, Diagram #2C. Said Certified Enrollment Node Diagram #10, at which said application has been created may not possess the capability to decrypt (un-encrypt) said application once saved in encrypted form. Prior to said submission 25, said encrypted application may or may not be re-encrypted for said transmission to Certification Authority.

During the process of validating the identity claimed within said application Diagrams #2A, #2B, & #2C, multiple steps occur, beginning with receipt of said enrollment application at Certification Authority. Said Enrollment Application 5, 10, 15, 25 is un-encrypted, and either becomes a part of a new Enrollment History Record Diagram #11 or is related to an existing Enrollment History Record 325 as appropriate, and which includes unique identifier for each of the Certification Node Diagram #10 on which it is being processed, and the operator of said enrollment node. Diagram #1 After applications evaluated for data integrity and completeness 75A, 75B, checking for previous enrollment of said applicant or their biometric 85A, and the steps of validating said identity and assigning or denying a specific Level of Trust. Diagram #2C, 95, 100.

In another preferred embodiment of this present invention, received applications are processed as follows, with several routes for the process to follow depending upon the outcome of each subsequent evaluation, and a notation of each outcome being added to the Enrollment History Record Diagram #11. In the first evaluation step, Application data within said application is evaluated for data integrity 75A. Data integrity evaluation in this context refers to an evaluation of data to determine said data has no recognized indication of having been altered since collected by Certified Enrollment Technician 5, 10, 15. Altered or corrupted application is rejected 185, applicant and Enrollment Node 195 is so informed, and applicant's identity certified at Disqualified Level of Trust 55. Enrollment profiles created and certified as Disqualified in this manner are held for a period of time 55 before being processed for enrollment Diagram #3. Said delay allows applicant opportunity to reapply. Profiles so certified as disqualified, for which no re-application is received within the allotted time are processed as noted. At this time, Certified Enrollment Profile 110, Diagram #3A and Master Enrollment record 115, Diagram #4A are created, forwarded and added to their respective databases, Enrollment History Record Diagram #11 is notated to reflect said steps, and added to the Enrollment History Database. Should Applicant subsequently re-apply: once new application is received in an unaltered form, is processed in accordance with standard methods described below for trust upgrade Diagram #7, with any changes in resultant Level of Trust Certification being duly reflected in Applicant's Certified Level of Trust 263, and appropriate update is made to applicant's enrollment profile and master enrollment record as a Trust Level Upgrade Diagram #7, with notations of said processing being included in Enrollment History Record Diagram #11.

In the second evaluation step Diagram #2B, application is evaluated for completeness with respect to data elements required for certification at the Objective Level of Trust requested by Applicant 5. Application determined to lack required data elements is held aside for a period of time 140, and applicant and Enrollment Node 5 are so informed 60. Applicant has a period of time to provide missing data elements. Without the timely receipt of missing data elements, applicant's application is rejected 150 and applicant's identity certified at Disqualified Level of Trust 170, and Certified Enrollment Profile Diagram #3A and Master Enrollment Record Diagram #4A are created reflecting said trust rating. Certified Enrollment Profile 110, Diagram #3A and Master Enrollment Record 115, Diagram #4A created and certified as Disqualified in this manner will be forwarded to respective Database Management Authority 120, 125, Diagrams 3 & 4 for enrollment. Said delay allows applicant additional opportunity to provide missing data elements. Enrollment History Record Diagram #11 is notated to reflect said steps and added to Enrollment History Database. Should Applicant subsequently submit necessary additional data, once said data is received in an unaltered form, application is processed in accordance with standard methods described below for Trust Level Upgrade Diagram #7, with any changes in resultant Level of Trust Certification being duly reflected in Applicant's Certified Trust Rating 263, and appropriate update being made to applicant's Certified Enrollment Profile 263, Master Enrollment Record 264, as a Trust Level Upgrade, with notations of said processing being included in Enrollment History Record 266. In the Third processing scenario Diagram #2C: application that is determined to be both unaltered and complete 80 is submitted for certification processing according to the method noted below. Once applicant identity is certified to a Level of Trust 100, Certified Enrollment Profile 110 and Master Enrollment Record 115, are created reflecting said trust rating, and forwarded to respective Database Management Authorities for enrollment 120, 125. As noted in above scenarios, Enrollment History Record Diagram #11 is updated to reflect steps taken.

In the system for validating the identity of Applicant, there are six possible Certified Levels of trust as illustrated in Diagram #9. The six levels of trust include, from lowest to highest rating: 1: Fraudulent 281, 2: Disqualified 282; 3: Not Independently Verifiable 283; 4: Basic 284; 5: Medium 285; and 6: High 286. The Certified Level of Trust Diagram #9 assigned to an identity is reflective of either the actual Objective Level of Trust Requested by Applicant 5, or the highest Level of Trust for which applicant's identity can be certified 100, whichever is lower, and, should Applicant's identity not qualify for Basic, they are certified and enrolled at “Disqualified” 282. Should disqualified identity be qualified to seek Not Independently Verifiable 283 certification, identity remains certified as “Disqualified” 282 until a Validator applies for and is certified on behalf of Applicant. In this scenario, Validator is processed by normal standards and, with certification, is enrolled at their own Certified Level of Trust Diagram #3A, Diagram #9 by normal means described in this invention, and deemed able to validate Not Independently Verifiable Applicant for enrollment, also by normal standards as described herein. At this time, Not Independently Verifiable Applicant's application is processed in accordance with standard methods for Not Independently Verifiable Applicant, with successful certification at that level being reflected in an update of their Certified Trust Rating from Disqualified 282 to Not Independently Verifiable 283, and appropriate update is made to applicant's Certified Enrollment Profile Diagram #3A and Master Enrollment Record Diagram #4A as a Trust Level Upgrade, with notations of said processing being included in Certification History Record Diagram #11, 222, 224.

In the system for Certifying an applicant for a Level of Trust Diagram #9, Diagrams 2A, 2B, &2C, the lowest level of Certified Trust in this present invention (for which an applicant would apply) is termed Not Independently Verifiable 283. This Certification level is intended for use by those individuals who, due to their age or for other reasons have not yet been provided a government-issued form of identification and whose identity is therefore difficult to validate without the reference of an individual who can vouch for or testify to their identity. Such individual is defined as their “Validator”. Said Not Independently Verifiable 283 Level of Trust allows the use of a Validator who is a parent or legal guardian of Applicant and whose identity is certified to a minimum of a Basic Level of Trust 284, or who is a public official whose identity is certified to a minimum of a Medium Level of Trust 285, or who is an administrator at Applicant's school whose identity is certified to a minimum of a Basic Level of Trust 284. Validator also provides, in addition to a statement of cause for their qualification as Validator for Applicant, a form of documentation to authenticate Validator's claimed relationship to Applicant along with a statement as to the authenticity of the provided document signed by Validator. For a parent or legal guardian of Applicant, a copy of a tax return (Form 1040, 1040A or other completed Tax Return, attachments not required) declaring Applicant as a dependent will be acceptable; for a public official, a copy of some form of public record or other documentation as to how applicant is known to them, and that Applicant resides within their jurisdiction will be accepted; For an administrator at Applicant's school: evidence of said administrator's position at applicant's school and a copy of applicant's report card or transcript from said school will be required.

In the system for Certifying an applicant for the Not Independently Verifiable Certified Level of Trust 283, Diagram #9, Applicant will present to a Certified Enrollment Technician 1 at a Certified Enrollment Node 1, Diagram #10 and provide the necessary authorizations, identity documentation, biometric samples, and other data as is required for consideration at the Not Independently Verifiable Certified Level of Trust Diagram #1, #5, #10. Applicant will also require validation by either of an individual with a previously certified identity who meets the Validator requirements for said Applicant, or a co-applicant who meets said Validator requirements. In either case, Validator authorizes that their identity be used as Validator for Applicant and provides a statement of cause for their qualification as Validator for applicant which is signed by Validator in the presence of Certified Enrollment Technician 5. Claims made within said statement of cause are considered along with standard data elements required for certification of Applicant and Validator (if Validator's identity is not already certified to the required minimum Level of Trust). Not Independently Verifiable Level of Trust 283 expires on the 17^{th} birthday of those certified at that level. Expired certifications are changed to “Disqualified” Level of Trust 282, which may be upgraded to another certified level by following appropriate upgrade procedures Diagram #7. Documents required to establish identity at the Not Independently Verifiable Certified Level of Trust 283, Diagram #9 include at least two of the following: 1) School ID card with a photograph; 2) Military dependent's ID card; 3) Native American tribal document; 4) Driver's license issued by a Canadian government authority; 5) U.S. Passport; 6) Un-expired Employment Authorization Document issued by the INS which contains a photograph (INS Form I-688B, or a replacement form if I-688B discontinued by INS); 7) *Employer ID Card with a photograph; 8) *School record or report card; 9) *Clinic, doctor, or hospital record 10) *Day-care or nursery school record. *NOTE: For items numbered 7, 8, 9, and 10 above, additional address and or contact information will be required.

In the system for Certifying an applicant for the Not Independently Verifiable Level of Trust 283, Certification Center, (after receipt of Applicant's application in an acceptable form as noted above 75A & 75B), a duplication check will be performed by comparing the base identity and biometric data provided by Applicant to the Master Enrollment Records Diagram #2C, 85A within the Master Enrollment File Diagram #4 to ensure that Applicant's identity is not previously enrolled, or enrolled in association with a different biometric(s), or that Applicant's biometric(s) is not previously enrolled in association with a different identity. Given no duplication is found, Certification Authority proceeds with process to validate Applicant's identity by validating the authenticity of at least one of the identity documents provided by applicant, as well as validating the authenticity of Validator's statement of cause for their qualification as Validator. Given satisfactory validation of at least one of the documents provided by applicant, and confirmation of Validator's required minimum Certified Level of Trust Diagram #9, and validation of said statement of cause, Applicant will be certified at the Not Independently Verifiable Level of Trust 100. Master Enrollment Record Diagram 4A, Diagram #2C, 115 and Certified Enrollment Profile Diagram #3A, Diagram #2C, 100 will be generated and forwarded to the respective Administration Authorities for the Master Enrollment File 120 and Certified Biometric Authentication Databases 125 as described below in system for Enrollment of Certified Profiles into Authentication Databases. In the event a duplicate or previous enrollment is detected 85A, said previous enrollment will be evaluated to confirm that previous enrollment actually reflects Applicant 85B (Is a duplicate). In event Applicant is previously enrolled with same Identity/biometric pairing 85C, 85D, existing Certified Enrollment Profile 110 will remain active, processing will stop on new application, and attempted duplicate enrollment will be noted as such 85D in Applicant's existing Enrollment History Database Record Diagram #11. Should a detected duplication result in the determination of previous enrollment with a different identity or biometric than was provided by Applicant in current application 85E, both current application and pre-existing profiles will be Certified as Disqualified with a fraud flag attached 85E, and Master Enrollment Record Diagram 4A, Diagram #2C, 115 and Certified Enrollment Profile Diagram #3A, Diagram #2C, 110 will be updated or generated as appropriate and returned or forwarded to the respective Administration Authorities for the Master Enrollment File 120 and Certified Biometric Authentication Database 125. In this instance, owners of each effected record will be notified of the occurrence and notified of their right to challenge or correct the discovered anomaly. Should such an effort me made, same process as System For Upgrading Certified Level of Trust Diagram #7 will be followed, except that a statement as to the cause or explanation of the anomaly, if any is known, will also be required in signed form from Applicant.

In the system for Certifying an applicant for the Basic Certified Level of Trust Diagram #9, 284, Applicant will present to a Certified Enrollment Technician at a Certified Enrollment Node Diagram #10, Diagram #1, 1 and provide the necessary authorizations, documentation, identity documentation, biometric samples, and other data as is required 5 for certification at the Basic Certified Level of Trust 284, Diagram #9. For this Objective Level of Trust, documents required to establish identity at said Certified Level of Trust include at least two of the following, at least one of which must be any of numbers 1, 2, 3, 5, 6, or 8, and at least one of these must include a photograph. Said documents include: 1) Driver's License or ID card issued by a state or outlying possession of the United States, provided it contains a photograph or information such as name, date of birth, gender, height, eye color, and address; 2) ID card issued by federal, state, or local government agencies or entities, provided it contains a photograph or information such as name, date of birth, gender, height, eye color, and address; 3) School ID card with a photograph; 4) Voter's registration card; 5) U.S. Military ID card or draft record; 6) Military dependent's ID card; 7) U.S. Coast Guard Merchant Mariner Card; 8) Native American tribal document; 9) Driver's license issued by a Canadian government authority; 10) U.S. Passport; 11) Un-expired Employment Authorization Document issued by the INS which contains a photograph (INS Form I-688B, or a replacement form if I-688B discontinued by INS); 12)*Employer ID Card with a photograph. *NOTE: For item numbered 12 above, additional address and or contact information will be required.

In the system for Certifying an applicant for the Basic Certified Level of Trust Diagram #9, 284, Certification Center, (after receipt of Applicant's application in an acceptable form as noted above 75), a duplication check will be performed by comparing the base identity and biometric data provided by Applicant to the Master Enrollment Records Diagram #2C, 85A within the Master Enrollment File Diagram #4 to ensure that Applicant's identity is not previously enrolled, or enrolled in association with a different biometric(s), or that Applicant's biometric(s) is(are) not previously enrolled in association with a different identity. Given no match is found, Certification Authority proceeds with process to validate Applicant's identity by validating the authenticity of a minimum of the required identity document, and that Applicant's Social Security Number matches their claimed identity. Given satisfactory validation of said elements, Applicant is certified at the Basic Level of Trust. Master Enrollment Record Diagram 4A, Diagram #2C, 115 and Certified Enrollment Profile Diagram #3A, Diagram #2C, 110 will be generated and forwarded to the respective Administration Authorities for the Master Enrollment File 120 and Certified Biometric Authentication Databases 125 as described below in system for Enrollment of Certified Profiles into Authentication Databases Diagram #3. In the event a duplicate or previous enrollment is detected, said previous enrollment will be re-evaluated to confirm that previous enrollment actually reflects Applicant Diagram #2C, 85B. In event Applicant is previously enrolled with same Identity/biometric pairing 85C, 85D, existing Certified Enrollment Profile 110 will remain active, processing will stop on new application, and attempted duplicate enrollment will be noted as such 85D in Applicant's existing Enrollment History Database Record Diagram #11. Should a detected duplication result in the determination of previous enrollment with a different identity or biometric 85C, 85E than was provided by Applicant in current application 85E, both current application and pre-existing profiles will be Certified as Disqualified with a fraud flag attached 85E, and Master Enrollment Record Diagram 4A, Diagram #2C, 115 and Certified Enrollment Profile Diagram #3A, Diagram #2C, 110 will be updated or generated as appropriate and returned or forwarded to the respective Administration Authorities for the Master Enrollment File 120 and Certified Biometric Authentication Database 125. In this instance, owners of each effected record will be notified of the occurrence and notified of their right to challenge or correct the discovered anomaly. Should such an effort me made, same process as System For Upgrading Certified Level of Trust Diagram #7 will be followed, except that a statement as to the cause or explanation of the anomaly, if any is known, will also be required in signed form from Applicant.

In the system for Certifying an applicant for the Medium Certified Level of Trust Diagram #9, 285, Applicant will present to a Certified Enrollment Technician 1 at a Certified Enrollment Node Diagram #1, 1, Diagram #10 and provide the necessary authorizations, documentation, identity documentation, biometric samples, and other data as is required 5, 10 for certification at the Medium Certified Level of Trust Diagram #9, 285. For this Objective Level of Trust, documents required to establish identity include at least two of the following, at least one of which must be any of numbers 1, 2, 3, 5, 6, or 8, and at least one of these must include a photograph. Said documents include: 1) Driver's License or ID card issued by a state or outlying possession of the United States provided it contains a photograph or information such as name, date of birth, gender, height, eye color, and address; 2) ID card issued by federal, state, or local government agencies or entities, provided it contains a photograph or information such as name, date of birth, gender, height, eye color, and address; 3) School ID card with a photograph; 4) Voter's registration card; 5) U.S. Military ID card or draft record; 6) Military dependent's ID card; 7) U.S. Coast Guard Merchant Mariner Card; 8) Native American tribal document; 9) Driver's license issued by a Canadian government authority; 10) U.S. Passport; 11) Un-expired Employment Authorization Document issued by the INS which contains a photograph (INS Form I-688B, or a replacement form if I-688B discontinued by INS); 12) *Employer ID Card with a photograph. *NOTE: For item numbered 12 above, additional address and or contact information will be required.

In addition to the requirement for documents as noted above, the system for certification at the Medium Certified Level of Trust Diagram #9, 285 includes an additional requirement that at least once, a duly authorized representative of the Certification Authority will meet face to face with Applicant at a physical location claimed by Applicant as either their workplace or home address, with a record of said meeting being comprised of a meeting completion document, completed by said representative at the meeting, and which includes name and at least one biometric from each of said representative and Applicant, and a statement as to the meeting location and time. Additionally, some evidence of applicant's association with said meeting location is to be provided by applicant and made a part of meeting completion document. If meeting is held at applicant's place of residence, a piece of mail from a billing entity to applicant at said address will be acceptable. If said meeting is held at applicant's place of employment, a pay stub reflecting applicant's employment, along with evidence that said employer is at said address will be required. If said employer address is reflected on paystub, said paystub will satisfy both requirements. If address of employer is different on said paystub, then letterhead of employer or business card reflecting said claimed employer address will be acceptable. This meeting may be either at the time of initial application, completed and documented by Certified Enrollment Technician 5, 10, or at a subsequent time with such a duly authorized representative of Certification Authority as required to satisfy the face to face meeting requirement. Said meeting completion document is to be saved in encrypted form as is th application itself, though not necessarily at the same time.

In the system for Certifying an applicant for the Medium Level of Trust Diagram #9, 285, Certification Center, (after receipt of Applicant's application in an acceptable form as noted above 75A, 75B), a duplication check will be performed by comparing the base identity and biometric data provided by Applicant to the Master Enrollment Records Diagram #2C, 85A within the Master Enrollment File Diagram #4 to ensure that Applicant's identity is not previously enrolled, or enrolled in association with a different biometric(s), or that Applicant's biometric(s) is not previously enrolled in association with a different identity. Given no duplication is found, Certification Authority proceeds with process to validate Applicant's identity by validating the authenticity of at least two of the identity documents, and that Applicant's Social Security Number matches their claimed identity. Given satisfactory validation of said documents, Applicant will be certified at the Medium Level of Trust. Diagram #9, 285, Master Enrollment Record Diagram #4A, Diagram #2C, 115 and Certified Enrollment Profiles Diagram #3A, Diagram #2C, 110 will be generated and forwarded to the respective Administration Authorities for the Master Enrollment File 120 and Certified Biometric Authentication Databases 125 as described below in system for Enrollment of Certified Profiles into Authentication Databases. In the event a duplicate or previous enrollment is detected, said previous enrollment will be evaluated to confirm that previous enrollment actually reflects Applicant 85B. In event Applicant is previously enrolled with same Identity/biometric pairing 85C, 85D, existing Certified Enrollment Profile 110 will remain active, processing will stop on new application, and attempted duplicate enrollment will be noted as such 85D in Applicant's existing Enrollment History Database Record Diagram #11. Should a detected duplication result in the determination of previous enrollment with a different identity or biometric than was provided by Applicant in current application 85E, both current application and pre-existing profiles will be Certified as Disqualified with a fraud flag attached 85E, and Master Enrollment Record Diagram 4A, Diagram #2C, 115 and Certified Enrollment Profile Diagram #3A, Diagram #2C, 110 will be updated or generated as appropriate and returned or forwarded to the respective Administration Authorities for the Master Enrollment File 120 and Certified Biometric Authentication Database 125. In this instance, owners of each effected record will be notified of the occurrence and notified of their right to challenge or correct the discovered anomaly. Should such an effort me made, same process as System For Upgrading Certified Level of Trust Diagram #7 will be followed, except that a statement as to the cause or explanation of the anomaly, if any is known, will also be required in signed form from Applicant.

In the system for Certifying an applicant for the High Certified Level of Trust Diagram #9, 286, Applicant will present to a Certified Enrollment Technician at a Certified Enrollment Node 1, Diagram #10 and provide the necessary authorizations, documentation, identity documentation, biometric samples, and other data as is required for certification at the High Certified Level of Trust Diagram #9, 286. For this Objective Level of Trust, documents required to establish identity include at least three of the following, at least one of which must be any of numbers 1, 2, 3, 5, 6, or 8, and at least two of these must include a photograph. Said documents include: 1) Driver's License or ID card issued by a state or outlying possession of the United States provided it contains a photograph or information such as name, date of birth, gender, height, eye color, and address; 2) ID card issued by federal, state, or local government agencies or entities, provided it contains a photograph or information such as name, date of birth, gender, height, eye color, and address; 3) School ID card with a photograph; 4) Voter's registration card; 5) U.S. Military ID card or draft record; 6) Military dependent's ID card; 7) U.S. Coast Guard Merchant Mariner Card; 8) Native American tribal document; 9) Driver's license issued by a Canadian government authority; 10) U.S. Passport; 11) Un-expired Employment Authorization Document issued by the INS which contains a photograph (INS Form I-688B, or a replacement form if I-688B discontinued by INS); 12)*Employer ID Card with a photograph. *NOTE: For item numbered 12 above, additional address and or contact information will be required.

In addition to the requirement for documents as noted above, the system for certification at the High Certified Level of Trust Diagram #9, 286 includes an additional requirement that there be a minimum of two meetings with Applicant and a duly authorized representative of Certification Authority. Said duly authorized representative of the Certification Authority will meet face to face with Applicant at a physical location claimed by Applicant as their home address, with a record of said meeting being comprised of a meeting completion document, completed by said representative at the meeting, and which includes name and at least one biometric from each of said representative and Applicant, and a statement as to the meeting location and time. In addition, Applications for the High Certified Level of Trust Diagram #9, 286 are to be completed within the perimeter of either Applicant's primary workplace (provided Applicant's employer is an entity of at least 25 employees and it can be documented that said entity has been at the same address for a minimum of one year), or completed within the perimeter of a facility managed by Certification Authority for that purpose. As is required of other face-to-face meetings, a record of said application creation meeting is to be completed by Certified Enrollment Technician at the meeting, being comprised of a meeting completion document which includes name and at least one biometric from each of said Certified Enrollment Technician and Applicant, and a statement as to the location and time at which Application was completed as is required to satisfy the face to face meeting requirements. Additionally, some evidence of applicant's association with said meeting location is to be provided by applicant and made a part of meeting completion document. If meeting is held at applicant's place of residence, a piece of mail from a billing entity to applicant at said address will be acceptable. If said meeting is held at applicant's place of employment, a pay stub reflecting applicant's employment, along with evidence that said employer is at said address will be required. If said employer address is reflected on paystub, said paystub will satisfy both requirements. If address of employer is different on said paystub, then letterhead of employer or business card reflecting said claimed employer address will be acceptable. This meeting may be either at the time of initial application, completed and documented by Certified Enrollment Technician 5, 10, or at a subsequent time with such a duly authorized representative of Certification Authority as required to satisfy the face to face meeting requirement. Said application meeting document is to be saved in encrypted form as is the application itself, though not necessarily at the same time.

An additional requirement for the High Certified Level of Trust Diagram #9, 286 is a validation by Law Enforcement in the form of a positive response to the question as to whether Law enforcement records reflect that Applicant's history is free from evidence of Applicant having assumed either alias or alternate identities, and that Applicant's history is also free from convictions for fraudulent or deceptive behavior. Said response from law enforcement will come in the form of yes or no to said request, with an affirmative answer indicating the absence of such history being a requirement for certification at a High Certified Level of Trust Diagram #9, 286.

In the system for Certifying an applicant for the High Level of Trust Diagram #9, 286, Certification Center, after receipt of Applicant's application in an acceptable form as noted above, a duplication check 85A will be performed by comparing the identity and biometric data provided by Applicant to the Master Enrollment Records within the Master Enrollment File Diagram #4 to ensure that Applicant's identity is not previously enrolled, not previously enrolled in association with a different biometric(s), or that Applicant's biometric(s) is(are) not previously enrolled in association with a different identity. Given no duplication is found, Certification Authority proceeds with process 95 to validate Applicant's identity by validating the authenticity of at least three of the identity documents, and that Applicant's Social Security Number matches their claimed identity. Given satisfactory validation of said documents, an affirmative response from law enforcement as previously described, and satisfactory completion of required face-to-face meetings and related documents, Applicant will be certified at the High Level of Trust Diagram #9, 286. Master Enrollment Record Diagram #4A and Certified Enrollment Profiles Diagram #3A will be generated and forwarded to the respective Administration Authorities for the Master Enrollment File 120 and Certified Biometric Authentication Databases 125 as described below in system for Enrollment of Certified Profiles into Authentication Databases. In the event a duplicate or previous enrollment is detected, said previous enrollment will be evaluated to confirm that previous enrollment actually reflects Applicant 85B. In event Applicant is previously enrolled with same Identity/biometric pairing 85C, 85D, existing Certified Enrollment Profile 110 will remain active, processing will stop on new application, and attempted duplicate enrollment will be noted as such 85D in Applicant's existing Enrollment History Database Record Diagram #11. Should a detected duplication result in the determination of previous enrollment with a different identity or biometric than was provided by Applicant in current application 85E, both current application and pre-existing profiles will be Certified as Disqualified with a fraud flag attached 85E, and Master Enrollment Record Diagram 4A, Diagram #2C, 115 and Certified Enrollment Profile Diagram #3A, Diagram #2C, 110 will be updated or generated as appropriate and returned or forwarded to the respective Administration Authorities for the Master Enrollment File 120 and Certified Biometric Authentication Database 125. In this instance, owners of each effected record will be notified of the occurrence and notified of their right to challenge or correct the discovered anomaly. Should such an effort me made, same process as System For Upgrading Certified Level of Trust Diagram #7 will be followed, except that a statement as to the cause or explanation of the anomaly, if any is known, will also be required in signed form from Applicant.

The system for Enrollment of Certified Profiles into Authentication Databases commences with the certification of an identity to a specific Level of Trust. Once so certified, three records are created, including a Certified Authentication Profile Diagram #3A, a Master Enrollment Record Diagram #4A, and an Enrollment History Record Diagram #11.

In the System to create the Certified Authentication Profile Diagram #3A discrete data elements are extracted from the processed Application. These data elements include the certified identity's name and biometric data, Certified Level of Trust Diagram #9, and a unique enrollment number that identifies each of the Certified Enrollment Profile Diagram #3A, Certifying Authority, and the Database Management Authority that manages the authentication database into which the Certified Enrollment Profile Diagram #3A is to be enrolled. Said Certified Profile 110 is forwarded to said Database Management Authority 125 which enrolls said profile into the database Diagram #3 and confirms said enrollment to Certifying authority. Said confirmation is added to Enrollment History Record Diagram #11. Said Authentication Database is used to provide Authentication Services to those authorized by Authentication Database Management Authority to access such services.

In the System to create the Master Enrollment Record Diagram #4A, 115, the Certified Enrollment Profile Diagram #3A, 110 is copied, with the unique identification number enhanced in a manner that identifies resulting Record as a Master Enrollment Record Diagram #4A, and correlates it to the Certified Enrollment Profile Diagram #3A, that it is a copy of. Said Master Enrollment Record Diagram #4A, once created, is added to Master Enrollment File Diagram #4, 120, which is a database comprised solely of Master Enrollment Records. A confirmation of the receipt of said Record, and its successful addition to said Master Enrollment File Diagram #4, 224 is returned to Certification Authority and added to Enrollment History Record Diagram #11.

In the System to create the Enrollment History Record Diagram #11, an Application that has been processed to an assigned Level of Trust, and from which Certified Enrollment Profile Diagram #3A, 110 and Master Enrollment Record Diagram #4A, 115 have each been generated and forwarded to their respective database management authorities, with receipts for each and acknowledgements of successful addition to their respective databases is considered to be complete. Complete Applicant History Record also includes the numbers assigned to each of the Certified Enrollment Profile Diagram #3A, 110 and Master Enrollment Record Diagram #4A, 115 generated from it, and is added to the Enrollment History Database. From time to time, as updates to specific History records are generated, said records are updated accordingly. History Database maintains a History Database Audit File comprised solely of numbers assigned to Master Enrollment Records Diagram #4A, 115.

In a preferred embodiment of this present invention; privacy of enrollees may be protected by the physical separation of the Enrollment History database from any other computer except for an attached pc, attached only for the purpose of managing the physical movement of non-eraseable, single write storage media containing updates to the history database, and copies of history records when such movement is required, and attached only to the history database container. To accommodate such movement, history updates and requests for copies of history records will post to an update file which is burned to the media, validated for effective copying, and erased from the network. Upon completion of listed tasks, said media is then moved to history database-attached PC to upload updates in a batch mode and the requested copies are loaded onto similar media for transfer back to the network. Such physical separation reduces risk from compromised access to the history to only those records in process for certification, or updates in the update file awaiting upload. Said used media will be retained as hard copy of history related transactions.

In the System to Audit the Authentication Database Diagram #5, Master Enrollment File is first compared to the History Database Audit File to validate that a proper history record number exists for each record in the Master Enrollment File to first validate the Master Enrollment File. Certified Authentication Database is then compared to Master Enrollment File 231 to ensure that the database contains only Certified Enrollment Profiles, and then compares said enrollment profiles to their counterparts in the Master Enrollment File to ensure that the Certified Authentication Profile has not been altered since being added to the Certified Authentication Database. Any altered and/or unauthorized profiles and records are moved to an inspection database 232: a database segregated from the others intended for the close inspection and potential repair of profiles and records that appear to be altered or fraudulent. Altered and/or unauthorized profiles and records are audited to detect any evidence of involvement by identifiable entities 233 in the alteration or unauthorized addition of any of these records. Altered and/or unauthorized profiles and records are checked for possible duplication 234 with other identities or biometrics within the Master Enrollment File Diagram #4, 231. Implicated duplicate profiles are flagged for possible fraud 235. Altered profiles are repaired and returned to original configuration based upon their configuration within the Master Enrollment File 236, and Unknown identities and or biometrics removed from altered authentication profiles during repair are certified at disqualified Level of Trust and flagged for possible fraud 236. Unauthorized profiles are certified at Fraudulent Level of Trust 237, Diagram #9. When any profile or record is updated or certified in such a manner, Certified Enrollment Profile and Master Enrollment Record 238 are generated and an enrollment history file is duly generated and/or updated to reflect these events, and identity owner(s) is(are) duly notified.

In the system to update data within an applicant file Diagram #6: applicant presents to enrollment node with requests to add or update personal information 241. Said Applicant is biometrically authenticated to confirm identity 242. If authentication yields an unsuccessful result, update request is denied 248. Given a successful authentication, applicant is allowed to submit updated data 245, which is in turn, forwarded to Enrollment History Record Diagram #11, 246 as a history update. Requested changes will be made to said record, with history annotated to reflect the change, and authentication records included in history file for each of Applicant and authorized representative of Certification Authority who enabled the changes being included in the history record. By definition, an update does not necessarily effect the enrollment profile, rather updates the personal data of Applicant in History File. Therefore, this process may leave both Certified Enrollment Profile Diagram #3A, 110 and Master Enrollment Record Diagram #4A, 115 unchanged. In the event of an update that includes a name change, updated Certified Enrollment Profile Diagram #3A, 110 and Master Enrollment Record Diagram #4A, 115 are generated, with said updated profile and record being numbered in a manner that reflects the original numbers, and forwarded to respective database management authorities for the replacement of the existing profile and record. Once so replaced and once said replacements are validated by respective database management authorities as having been successfully completed: Application History File will be updated to reflect said processing and changes.

In the system to upgrade the Certified Level of Trust Diagram #7: applicant presents in person to enrollment node with upgrade request 251. Said Applicant is biometrically authenticated to confirm identity 252. If authentication yields an unsuccessful result, upgrade request is denied 255. Given a successful authentication, applicant is allowed to submit additional and/or contextually required data elements 256 to certified enrollment technician as is required for certification at the increased trust level. Certified enrollment technician creates upgrade application 257 from additional data, which is, in turn, saved and then forwarded to certification center 258 for processing. Certification center obtains copy of applicant's Enrollment History Record Diagram #11, 259 to provide remainder of data required for processing 260 and possible certification upgrade request from applicant. If requirements are met 261 for certification at a higher level, a profile upgrade authorization is submitted to authentication database 263 and Master Enrollment File 264 for appropriate upgrade installation. Transaction codes to document successful installations 266 in each are added to the history record as a history update. If trust certifications are not met, no changes are made except to the enrollment history profile which is updated to reflect said denial of upgrade request.

In the system to allow the voluntary withdrawal of a certified enrollment profile Diagram #8 from the authentication database: applicant presents to enrollment node with request to withdraw 271. Said Applicant is biometrically authenticated to confirm identity 272. If authentication yields an unsuccessful result, request is denied 275. Given a successful authentication, applicant's request is accepted 276, and withdrawals of said profile and the Master Enrollment File from their respective databases are authorized. Documentation of successful withdrawal 278, once completed, is forwarded to Enrollment History Record Diagram #11 as a history update to document the requested removal 279.

In the embodiment described above, a system is implemented that enables a level of identity-integrity that would not be otherwise available given current enrollment methods. The flexibility and consistency of the system are intended to allow a predictable level of confidence to direct and indirect users of this current invention, in the accuracy with which an implemented biometric authentication system allows for access decisions to be made, based upon consistently applied procedures for identity validation rather than on corruptible methods of determining identity. Such is important in situations where a variety of levels of sensitivity drive access control decisions, and is especially important where the consequences of a fraudulent penetration of access system(s) could be very high in terms of personal privacy, corporate survival, national security, or human life.

In addition, another benefit of this embodiment of the high-integrity enrollment system for biometric authentication databases may be that the nature of the system and identity verification included therein may deter the marginally dishonest individual, since they would know that the technology could positively identify them later, and that the certification step performed immediately might make them uncomfortable because of their desire to be secretive of their past, despite the fact that this invention does not investigate personal integrity, rather, it only investigates identity integrity.

Another embodiment of this current invention could further include external data source(s) having data relating to prior history of individuals. The data stored in external data source may be accessed by the biometric authentication system in an effort to validate a personal qualification the evidence for validation of which resides in said external data source. An example of this scenario includes the use of this system to validate that an individual has no history that would, in the eyes of law enforcement and according to their own database, prohibit their ability to lawfully purchase firearms in a manner consistent with the law.

In another preferred embodiment of this present invention: the high integrity enrollment system is utilized to support the use of biometrics intended to provide a basic yes/no response to the question of whether a specific individual is old enough to purchase an item that requires a purchaser to meet a minimum age requirement in order to legally buy said item. Examples of such embodiments include but are not limited to age validation for the purchase of liquor, to limit the ability of under-aged individuals to gain entry to drinking establishments or their ability to buy alcohol at public eateries, or to control the sale of cigarettes to minors.

In another preferred embodiment of this present invention: the high integrity enrollment system is utilized to support the use of biometrics intended to control the access to specific services, limiting said access to only those people who are eligible to or entitled to receive them. Examples of such embodiments include but are not limited to control over access to welfare benefits, unemployment benefits, to food stamps, to subsidized healthcare, or MediCare. Cost associated with the fraudulent use of such services serves to reduce the availability of said services among the peoples who need them most, as well as to inflate the budgets required to provide such services, often to the point that they or other programs face termination or service reductions because of rising costs.

In another preferred embodiment of this present invention: the high integrity enrollment system is utilized to support the use of biometrics intended to control access to, and account for use of specific rights or privileges. Examples of such embodiments include but are not limited to voter registration and voter identification at election time, or to account for the number of times a specific service or privilege has been utilized by individuals who are granted a specific number of uses under their privilege, or a right to make purchases adding up to a maximum level of total expenditures. An example of these scenarios include access to rental cars, health spas or swimming pools, or pre-paid student lunches in the maximum expenditure scenario.

In another preferred embodiment of this present invention: the high integrity enrollment system is utilized to support the use of biometrics intended to eliminate identity fraud associated with the taking of certification exams. Examples of such embodiments include but are not limited to the taking of: Scholastic Aptitude Tests, (grades for which can qualify a person for scholarships, or for entry into prestigious universities); Graduate level Exams used to qualify for entrance to graduate level degree programs; Professional Certification Exams such as the Bar exam, medical board certification exams, CPA exams, Information Technology or other skills based certification exams. The results of this level of exam can significantly influence the earning potential of an individual who has invested heavily in terms of both time and money to earn related degrees and/or certifications, or to take associated training classes.

In another preferred embodiment of this present invention: the high integrity enrollment system is utilized to support the use of biometrics intended to control access to sensitive locations within our national infrastructure. Examples of such embodiments include but are not limited to systems designed to prevent the fraudulent breach of physical security which could enable criminals or terrorists to bring down a power grid, shut down air travel, blow up a dam or nuclear power plant, or perform other heinous acts.

In another preferred embodiment of this present invention: the high integrity enrollment system is utilized to support the use of biometrics intended to control access to our country itself at borders, airports or other entry points.

In another preferred embodiment of this present invention: the high integrity enrollment system is utilized to support the use of biometrics intended to control access to prioritized passage of trusted frequent passengers through security checkpoints. An example of such an application would include but not be limited to the identification of frequent fliers known to the airlines as preferred customers.

In another preferred embodiment of this present invention: the high integrity enrollment system is utilized to support the use of biometrics intended to manage fire control systems designed to prevent the unauthorized launch of missiles or weapons of mass destruction during times of war, or of peace. It may also control the communication of orders related to troop movements or deployment of other strategic assets during armed conflict.

In another preferred embodiment of this present invention: the high integrity enrollment system is utilized to support the use of biometrics intended to control access to areas deemed proprietary or otherwise sensitive to corporate citizens. Examples of such embodiments include but are not limited to systems designed to control access to corporate data centers, manufacturing facilities or research facilities, or even office space. This could also include on-site and/or remote electronic access to corporate data networks or data systems used for day to day business or to store trade secrets or other proprietary information.

In another preferred embodiment of this present invention: the high integrity enrollment system is utilized to support the use of biometrics intended to control access to technologies used to prove identity for e-commerce or to establish secured connectivity over public or private network infrastructures. Examples of such embodiments include but are not limited to systems designed to control access to and audit the use of digital certificates used to establish encrypted communications between business partners and/or associates, or to place or receive electronic orders for equipment, raw materials, or other products and supplies.

In another preferred embodiment of this present invention: the high integrity enrollment system is utilized to support the use of biometrics intended to enable the creation of an accurate audit trail for individuals who electronically access some service. Examples of such embodiments include but are not limited to applications to eliminate an individual's ability to deny that they performed some act that required a form of strong authentication to complete, such as in the corporate examples noted in the paragraph above, or access to services such as on-line stock trading where such fraudulent denial can be to a person's benefit if such a denial could not otherwise be proven to be fraudulent, or to monitor physical access of individuals to sensitive locations outside of or in addition to normal hours of access.

In another preferred embodiment of this present invention: the high integrity enrollment system is utilized to support the use of biometrics intended to maintain privacy of personal information. Examples of such embodiments include but are not limited to systems designed to the control of access to sources or repositories of personal medical data, or personal financial assets like bank accounts or stock trading accounts, or to limit that access to results of specific medical tests or other sensitive inquiries to only a few or even one select individual(s).

Another preferred embodiment of this present invention: the high integrity enrollment system is utilized to support the use of biometrics intended to provide access control security at public places served either by multiple vendors or contractors, or by a singular contractor. Such an example was described above in the context of access control at airports.

In another preferred embodiment of this present invention: the high integrity enrollment system is utilized to support the use of biometrics intended to support the use of smart cards for uses including but not limited to: Privately or publicly issued Identification cards, credit cards, or cards issued for other purposes.

The scenarios listed and claimed above as valid uses for this present invention that significantly improve the current art and would arguably provide significant enhancements to the quality and/or effectiveness of access controls implemented in those situations and according to such purposes as were described therein, demonstrate the broad applicability of this present invention. It is not implied or intended that this be an exhaustive list of, or the potential uses of the benefits afforded by this current invention, but rather that said examples demonstrate the broad applicability of said invention.

In Addition, the system and method according to the present invention of enabling identity-integrity within the context of biometric authentication of an individual using biometrics for granting certain privileges has significant value in situations where there are compelling needs for the accurate and reliable authentication of the identity of an individual. Many types of privileges are assigned to individuals and it is necessary to authenticate that the individual seeking access to such privileges is in fact the person that they claim to be.

Although illustrated and described herein with reference to certain specific embodiments, it will be understood by those skilled in the art that the invention is not limited to the embodiments specifically disclosed herein. Those skilled in the art also will appreciate that many other variations of the specific embodiments described herein are intended to be within the scope of the invention as defined by the following claims.

What is claimed is:

1. A system and method for the high-integrity enrollment of individual identities into biometric databases by controlling the process of enrollment comprising: a system for the Creation of Enrollment Applications; a system for certifying the probable validity of the identity claimed by a prospective enrollee (applicant) to one of several levels of trust; a system for the creation of authentication profiles, master enrollment records, and enrollment history records; a system for the addition of said profile and records into an authentication database, a master enrollment file, and an enrollment history database, respectively; a system for the periodic audit of the integrity of the authentication database and the authentication records contained therein; a system for updating data related to enrolled identities; a system for upgrading the level of certified trust associated with an identity in the authentication database; and a system to allow the voluntary withdrawal of authentication record from the authentication database.

2. The system according to claim 1, further comprising a system for creating an application for enrollment comprising: an enrollment node used for the collection of required data elements; a system for collecting the data elements required for creating enrollment applications, and a system to check for the previous enrollment of identity and/or biometric contained within said application;

3. The system according to claim 1, further comprising a system for certifying the probable validity of the identity claimed by a prospective enrollee, said system comprising: a system for validating the completeness of the application created pursuant to claim 1; a system for defining the various steps to be taken to validate said identity pursuant to the Level of Trust sought by applicant: a system for performing various numbers of steps to verify the validity of identity claimed by said applicant; a system to assign one of several levels of trust to the validity of the identity claimed by applicant based upon the steps taken in validating said identity and the quality of results obtained from said steps; a system to create profiles for a certified enrollment database, a master enrollment file, and an enrollment history database; and a system to add said profiles and records into said authentication database, master enrollment file, and enrollment history database.

4. The system according to claim 1, further comprising a system for the periodic audit of the integrity of the authentication database and the authentication records contained therein, said system comprising; a system to detect unauthorized enrollments; a system to detect enrollment profiles that were altered without authorization; and a system to weed out said unauthorized and altered profiles from the authentication database; and a system to repair and replace said altered profiles; and a system to maintain record of said repairs and replacements and removals.

5. The system according to claim 1, wherein the system for the addition of said profiles and records into an authentication database, master enrollment file, and enrollment history file includes a system to track the history regarding the execution of said additions,

6. The system according to claim 1, further comprising a system for updating data related to enrolled identities that includes a system to track the history regarding the execution of said updates;

7. The system according to claim 1, wherein the system for upgrading the level of certified trust associated with an identity in the authentication database includes a system to track the history regarding the execution of said upgrades;

8. The system according to claim 1, wherein the system for allowing the voluntary withdrawal of an authentication record from the authentication database includes a system to track the history regarding the execution of said withdrawals;
